(19) United States
(12) Patent Application Publication
(10) Pub. No.: US 2008/0026215 A1
(43) Pub. Date: Jan. 31, 2008

(54) PRINT-RECEPTIVE ELECTROSTATIC DISSIPATING LABEL

(75) Inventors: Luan Yie Wan, Singapore (SG); Hoke Woei Pang, Singapore (SG); Richard J. Webb, Inver Grove Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/460,675

(22) Filed: Jul. 28, 2006

(51) Int. Cl. G09F 3/10; B32B 7/12

(52) U.S. Cl. 428/354; 428/343; 40/638; 40/299.01

(57) ABSTRACT

A multi-layer label is described. The label includes a polymeric substrate having a print receptive layer on one major surface and a print contrast layer on the opposite major surface. The label also includes both an electrically conductive adhesive and an electrically conductive layer.

### FIELD

The present disclosure relates to print-receptive electrostatic dissipating labels. In some embodiments, the labels may be applied to static sensitive components such as hard disk drives.

### SUMMARY

Briefly, in one aspect, the present invention provides a print-receptive, electrostatic dissipating label comprising a print receptive layer adjacent a first major surface of a polymeric substrate, a print contrast layer adjacent a second major surface of the polymeric substrate opposite the print receptive layer, an electrically conductive layer adjacent the print contrast layer opposite the polymeric substrate, and an electrically conductive adhesive adjacent the electrically conductive layer opposite the print contrast layer. In some embodiments, the print receptive layer is transparent. In some embodiments, the print receptive layer comprises a polyvinylidene chloride resin and a polyester resin.

In some embodiments, the polymeric substrate is a transparent polymeric substrate. In some embodiments, the polymeric substrate comprises polyester. In some embodiments, the print contrast layer is opaque and, in some embodiments, the print contrast layer is white.

In some embodiments, the electrically conductive layer comprises a metal foil and, in some embodiments, the metal foil comprises aluminum. In some embodiments, the electrically conductive adhesive comprises an adhesive resin and a plurality of electrically conductive particles. In some embodiments, the adhesive resin comprises an acrylate. In some embodiments, the plurality of electrically conductive particles comprises nickel.

In some embodiments, the label further comprises a primer interposed between the electrically conductive layer and the electrically conductive adhesive. In some embodiments, the primer comprises phenolic and acrylic resins.

In some embodiments, the label further comprises an image comprising ink adjacent the print receptive layer opposite the polymeric substrate.

The above summary of the present invention is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates a print-receptive electrostatic dissipating label in accordance with an embodiment of the invention.

FIG. 2 illustrates the electrical resistance test.

### DETAILED DESCRIPTION

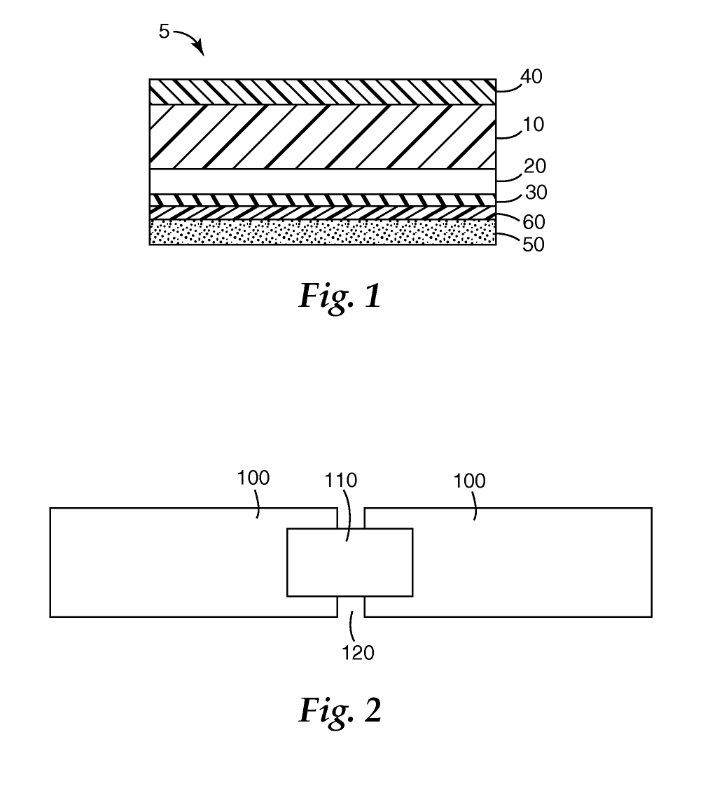

Referring to FIG. 1, print-receptive electrostatic dissipating label 5 is a multilayer construction. In some embodiments, label 5 comprises polymeric film 10, having first major surface 11 and second major surface 12, print contrast layer 20, adjacent second major surface 12 of polymeric film 10, and electrically conductive layer 30 adjacent print contrast layer 20, opposite polymeric film 10.

In some embodiments, print-receptive electrostatic dissipating label 5 further comprises print-receptive layer 40 adjacent first major surface 11 of polymeric film 10. In some embodiments, label 5 also comprises electrically conductive adhesive 50 adjacent electrically conductive layer 30, opposite print contrast layer 20. In some embodiments, label 5 also includes primer layer 60 interposed between electrically conductive layer 30 and electrically conductive adhesive 50.

In some embodiments, the polymeric film is a transparent polymeric film. As used herein, a film or layer is “transparent” if an object (e.g., another film or layer) is clearly visible through the transparent film or layer. In some embodiments, at least 25% (e.g., at least 50%, 75%, or even at least 90%) of visible light is transmitted through a transparent film or layer. In some embodiments, the polymeric film may comprise a single layer or multiple layers. In some embodiments, one or more layers of the polymeric film comprise one or more of a polyester (e.g., polyethylene terephthalate (PET) and polyethylene naphthalate (PEN)), a polyolefin (e.g., polypropylene and polyethylene), an ethylene vinyl acetate, a polycarbonate, a polyimide, and derivatives thereof.

In some embodiments, the print contrast layer is opaque. As used herein, a film or layer is “opaque” if an object (e.g., another film or layer) is not clearly visible through the opaque film or layer. In some embodiments, less than 25% (e.g., less than 15%, 10%, or even less than 5%) of visible light is transmitted through the film or layer. In some embodiments, the print contrast layer is white.

In some embodiments, the electrically conductive layer is a metal foil. Exemplary foils useful in some embodiments of the present disclosure include aluminum, copper, nickel, and alloys thereof. In some embodiments, the electrically conductive layer has sheet resistance of less than 50 ohms per square, in some embodiments, less than 40 ohms per square, or even less than 30 ohms per square.

In some embodiments, the metal foil is no greater than 100 micrometers thick; in some embodiments, no greater than 50 micrometers; in some embodiments, no greater than 20 micrometers; and, in some embodiments, no greater than 10 micrometers thick.

In some embodiments, the print receptive layer is transparent. In some embodiments, the print receptive layer comprises hydrophilic and aqueous ink sorptive coatings. Exemplary coatings include, but are not limited to, polyvinyl pyrrolidone, including homopolymers, copolymers, and substituted derivatives thereof; polyvinylidene chloride including homopolymers, copolymers, and derivatives thereof; polyethyleneimine and derivatives thereof; vinyl acetate copolymers (e.g., copolymers of vinyl acetate and vinyl pyrrolidone and copolymers of vinyl acetate and acrylic acid) and hydrolyzed derivatives thereof; polyvinyl alcohol, (meth)acrylic acid homopolymers and copolymers; polyesters and co-polyesters; acrylamide homopolymers and copolymers; cellulosic polymers; styrene copolymers with allyl alcohol, acrylic acid, and/or maleic acid, and esters thereof; alkylene oxide polymers and copolymers; gelatins and modified gelatins; polysaccharides; and combinations thereof.

As used herein, a “conductive adhesive” is electrically conductive through the thickness of the adhesive layer. In some embodiments, the conductive adhesive is also conductive in one or more dimensions in the plane of the adhesive layer. In some embodiments, the bulk resistivity of the conductive adhesive is less than 5 ohm per square centimeter through the thickness of the adhesive layer. In some embodiments, the bulk resistivity is less than 2 (e.g., less than 1 or even less than 0.5) ohm per square centimeter through the thickness of the adhesive layer. The electrical conductivity may be isotropic or anisotropic. Generally, any known adhesive composition may be used. Exemplary adhesive compositions include pressure sensitive adhesives, heat activated adhesives, thermoset adhesives, and curable adhesives.

Generally, the adhesive composition comprises an adhesive resin. In some embodiments, the adhesive resin comprises one or more of: polyacrylates; polyvinyl ethers; diene-containing rubbers; polychloroprenes; butyl rubbers; butadiene-acrylonitrile polymers thermoplastic elastomers; block copolymers of styrene-isoprene, styrene-isoprene-styrene, styrene-butadiene, and/or styrene-butadiene-styrene; ethylene-propylene-diene polymers; poly-alpha-olefins; amorphous polyolefins; silicones; ethylene-containing copolymers; polyurethanes; polyamides; epoxies; polyesters; polyvinylpyrrolidones and vinylpyrrolidone copolymers; and combinations thereof.

In some embodiments, the adhesive composition further comprises one or more additives such as tackifiers, plasticizers, dyes, pigments, and fillers.

In some embodiments, the conductive adhesive comprises electrically conductive particles. Generally, any known conductive particles may be used. Exemplary conductive particles include carbon particles or metal particles (e.g., silver, copper, nickel, gold, tin, zinc, platinum, palladium, iron, tungsten, molybdenum, solder, or the like). In some embodiments, the particles may be prepared by covering the surface of these particles with a conductive coating of a metal, or the like. In some embodiments, the conductive particles may be prepared by covering the surface non-conductive particles with a conductive coating of a metal, or the like. Exemplary non-conductive particles include particles comprising one or more of a polymer (e.g., polyethylene, polystyrene, phenol resin, epoxy resin, acryl resin, or benzoguanamine resin), glass, silica, graphite, or ceramic.

The electrically conductive particles may be of any shape including, e.g., spherical, ellipsoidal, cylindrical, flakes, needle, whisker, platelet, agglomerate, crystal, acicular, and combinations thereof. In some embodiments, the particles may have a slightly rough or spiked surface. In some embodiments, the particles are substantially spherical. The choice of particle shape may be affected by the rheology of the selected resin components and ease of processing of the final resin/particle mix. In some embodiments, combinations of particle shapes, sizes, and hardness may be used.

In some embodiments, the conductive adhesive contains a conductive scrim, including woven and nonwoven meshes.

In some embodiments, labels of the present disclosure include a primer interposed between the electrically conductive layer and the electrically conductive adhesive. Generally, any known primer may be used. Exemplary primers include phenolic resins, acrylic resins, methacrylic resins, polyvinylidene chloride resins, and combinations thereof.

In some embodiments, labels of the present disclosure may be used to provide a conductive path from the label to substrate to which it is attached, e.g., a disk drive cover, allowing static charges to be dissipated through the conductive metal backing and the electrically conductive pressure sensitive adhesive to substrate. In some embodiments, the substrate may then be electrically grounded. In some embodiments, labels of the present disclosure also preserve the integrity of the disk drive as a Faraday cage making the drive electromagnetically compatible.

In some embodiments, known inks (e.g., flexographic, off-set, gravure, ink jet, thermal transfer ink) may be applied to the print receptive using known means. The ink may be applied to create desired indicia including, e.g., text, numerals, graphics, barcodes, to the labels of the present disclosure. Generally, the ink and/or the print contrast layer may be selected to provide the desired degree of contrast. For example, in some embodiments, the print contrast layer may be white, while the ink is colored, e.g., black.

The following specific, but non-limiting, examples will serve to illustrate the invention. In these examples, all percentages are parts by weight unless otherwise indicated.

TABLE 1
Description of materials.

| HDNP-A/C-1-12 | Nickel particles | Novamet, Wykoff, New Jersey |
|---|---|---|
| 550 Adhesive | Acrylate adhesive | 3M Company, St. Paul, Minnesota |
| 553 Adhesive | Acrylate adhesive | 3M Company, St. Paul, Minnesota |

Four percent by weight of the HDNP-A/C-1-12 nickel particles were dispersed into either 553 Adhesive solution (Examples 1-3) or 550 Adhesive solution (Examples 4-18). The resulting dispersion was coated with a knife coater onto a release liner (LX-150, Loparex, Willowbrook, Ill.) and dried for ten minutes at 80 degrees C. to achieve an adhesive film thickness of 10 to 15 micrometers. A laminate of polyester (12 micrometers thick) and aluminum foil (6 micrometers thick) with an opaque white layer between the polyester and the foil was obtained from Superior Multi-Packaging Limited (7, Benoi Sector, Singapore). The side of the polyester film opposite the opaque white layer was coated with a print receptive layer by a gravure printing process. The print receptive layer contained polyvinylidene chloride resin and polyester resin.

The side of the aluminum foil opposite the opaque white layer was coated with a primer containing phenolic and acrylic resins using a gravure coating process. In some examples, the primer was diluted with methyl ethyl ketone (MEK) to achieve a thinner layer of primer after drying. The percent dilution is shown in Table 2.

The conductive adhesive film was laminated to the primer coated side of the aluminum foil. The final construction is as shown in FIG. 1. The thickness of the primer layer and the thickness of the total construction, excluding the liner, are shown in Table 2.

The conductive adhesive films of Examples 19-22 were prepared with two weight percent of the HDNP-A/C-1-12 nickel particles dispersed in 550 Adhesive solution. The dispersion was coated onto a release liner using a continuous web knife coater and dried in a forced air oven to achieve an adhesive film thickness of 10 to 15 micrometers. The oven had three 3.7 meter long zones and the temperatures in the three zones were 62.7 degrees C., 68.3 degrees C. and 73.8 degrees C., respectively. The web passed through the oven at 3.7 meters per minute. The conductive adhesive films of Examples 19-22 were laminated to the primer coated side of the aluminum foil substrate as described for Example 1.

Referring to FIG. 2, for each sample, two aluminum (2024 aircraft grade) panels 100 were cleaned with three wipes of isopropyl alcohol. A 2.5 centimeter (one inch) square piece of the conductive laminate 110 was cut and bonded to aluminum panels 100. Gap 120 of 1-2 millimeters was maintained between aluminum panels 100. The contact resistance was measured with a micro-ohmmeter and a four-point probe set by contacting each of the aluminum panels with one pair of probes near, but not touching, the conductive laminate. The initial resistance and the resistance after dwells of one hour and twenty-four hours are reported in Table 2.

TABLE 2
Sample description and electrical resistance measurements.

| | % dilution | Thickness | | | |
|---|---|---|---|---|---|
| | with MEK | (micrometers) | Electrical Resistance (Ohms) | | |
| Example | Primer | Product | Initial | 1 Hour | 24 Hours |
| 1 | 50% | 35 | 0.18 | 0.69 | 0.95 |
| 2 | 50% | 35 | 0.11 | 0.36 | 0.65 |
| 3 | 50% | 35 | 0.12 | 0.53 | 1.40 |
| 4 | 50% | 36 | 0.22 | 0.36 | 1.45 |
| 5 | 50% | 36 | 0.70 | 4.0 | 3.73 |
| 6 | 50% | 36 | 0.65 | 2.30 | 4.71 |
| 7 | No primer | 34 | 0.05 | 0.09 | 0.06 |
| 8 | No Primer | 34 | 0.04 | 0.05 | 0.07 |
| 9 | No primer | 34 | 0.03 | 0.05 | 0.15 |
| 10 | 50% | 34 | 0.07 | 0.12 | 0.18 |
| 11 | 50% | 34 | 0.11 | 0.16 | 0.13 |
| 12 | 50% | 34 | 0.06 | 0.10 | 0.30 |
| 13 | 90% | 33 | 0.14 | 0.20 | 0.30 |
| 14 | 90% | 33 | 0.10 | 0.13 | 0.24 |
| 15 | 90% | 33 | 0.20 | 0.28 | 0.35 |
| 16 | 0% | 34 | 0.14 | 0.13 | 0.14 |
| 17 | 0% | 34 | 0.30 | 0.43 | 0.48 |
| 18 | 0% | 34 | 0.07 | 0.12 | 0.21 |
| 19 | 70% | 34 | 0.21 | 0.44 | 0.52 |
| 20 | 70% | 34 | 0.40 | 3.62 | 2.77 |
| 21 | 70% | 34 | 0.32 | 0.42 | 0.45 |
| 22 | 70% | 34 | 0.27 | 0.33 | 0.40 |

The peel adhesion force was measured for examples with four weight percent nickel particles and with two weight percent nickel particles. Each adhesive sample was laminated to a stainless steel plate with a 6.8 kilogram roller. The steel plates had been wiped consecutively with methyl ethyl ketone, isopropyl alcohol:water (50:50) and three times with acetone. The force to remove the adhesive from the stainless steel plate at an angle of 90 degrees was measured with a Instron Tensile Tester (Instron Corporation, Norwood, Mass.). The peel force for some samples was measured immediately after laminating them to the stainless steel plate. The peel force for other samples was measured three days after the sample was laminated to the stainless steel plate. All samples were stored at ambient conditions. The peel force results are reported in Table 3 as Newton per centimeter (N/cm).

TABLE 3
Peel Force results (N/cm).

| Example | Initial | Three day aged |
|---|---|---|
| 4% Nickel | 1.86 | 2.20 |
| 2% Nickel | 2.22 | 2.68 |

Various modifications and alterations of this invention will become apparent to those skilled in the art without departing from the scope and spirit of this invention.

What is claimed is:

1. A print-receptive, electrostatic dissipating label comprising a print receptive layer adjacent a first major surface of a polymeric substrate, a print contrast layer adjacent a second major surface of the polymeric substrate opposite the print receptive layer, an electrically conductive layer adjacent the print contrast layer opposite the polymeric substrate, and an electrically conductive adhesive adjacent the electrically conductive layer opposite the print contrast layer.

2. The label of claim 1, wherein the print receptive layer is transparent.

3. The label of claim 1, wherein the print receptive layer comprises a polyvinylidene chloride resin and a polyester resin.

4. The label of claim 1, wherein the polymeric substrate is a transparent polymeric substrate.

5. The label of claim 1, wherein the polymeric substrate comprises polyester.

6. The label of claim 1, wherein the print contrast layer is opaque.

7. The label of claim 1, wherein the print contrast layer is white.

8. The label of claim 1, wherein the electrically conductive layer comprises a metal foil.

9. The label of claim 1, wherein the metal foil comprises aluminum.

10. The label of claim 1, wherein the electrically conductive adhesive comprises an adhesive resin and a plurality of electrically conductive particles.

11. The label of claim 10, wherein the adhesive resin comprises an acrylate.

12. The label of claim 10, wherein the plurality of electrically conductive particles comprise nickel.

13. The label of claim 1, further comprising a primer interposed between the electrically conductive layer and the electrically conductive adhesive.

14. The label of claim 13, wherein the primer comprises phenolic and acrylic resins.

15. The label of claim 1, further comprising an image comprising ink adjacent the print receptive layer opposite the polymeric substrate.
